(19) United States
(12) Patent Application Publication
(10) Pub. No.: US 2004/0222012 A1
(43) Pub. Date: Nov. 11, 2004

(54) Small-gauge signal cable and its method of use

(75) Inventor: Paul M. Wlos, Bourbonnais, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Electron Beam Technologies, Inc., Kankakee, IL

(21) Appl. No.: 10/430,848

(22) Filed: May 6, 2003

(51) Int. Cl. H01B 5/08

(52) U.S. Cl. 174/128.1

(57) ABSTRACT

A small-gauge signal cable has a fiber core of a strong fiber such as aramid, a plurality of conductor wires stranded around the fiber core, a coating of conductive polymer over the stranded conductor wires, and an outer jacket. The fiber core gives the cable greater flexibility and break strength. The conductive coating serves as a protective layer to allow the outer jacket to be stripped easily without damaging the conductor wires. A connector is installed on the cable by crimping the connector directly onto the conductive polymer coating. The conductive polymer coating provides retention of the conductor wires in the proper concentric fabricated orientation for reduced wire fatigue at the point adjacent the connector.

The present invention relates generally to electrical cables, and more particularly, to the design and use of a small-gauge signal cable.

### BACKGROUND OF THE INVENTION

Signal cables are widely used in home appliances and other applications for carrying control signals. Because such cables are not required to carry any substantial amount of current, they can be made fairly thin, and high flexibility and reliability are often an important design criteria for such cables. To further improve the flexibility of the cables, the conductor wires used therein are typically thin stranded wires.

There are, however, several problems associated with using a thin cable. Because the cable thin, it typically is not very strong and can be broken easily. Moreover, to terminate the cable with a connector, the protective outer insulation layer or jacket of the cable has to be stripped so that a connector can be crimped onto the conductor wires. Because the conductor wires in the cable are very thin, it is often difficult to strip the insulation layer cleanly without breaking off some of the conductor wires. Also, it can be difficult to reliably attach a connector to the thin conduction wires by crimping. Moreover, the wires adjacent the connector become a major fatigue point. If the cable is moved around a lot during use, the thin conductor wires tend to break at that point.

### SUMMARY OF THE INVENTION

In view of the foregoing, the present invention provides a new design of a small-gauge gauge signal cable that has improved flexibility and break strength and allows easy stripping and reliable termination with a connector by crimping. The signal cable has a fiber core of a strong fiber such as aramid, a plurality of conductor wires stranded around the fiber core, a coating of conductive polymer over the stranded conductor wires, and an outer insulation layer (or jacket). The fiber core gives the cable enhanced flexibility and break strength. The conductive polymer coating serves as a protective overlayer for the conductor wires, thus allowing the outer insulation layer to be stripped easily without damaging the conductor wires. The conductive polymer coating also allows easy installation of a connector to the cable because the connector can be crimped onto the conductive polymer coating. Moreover, it provides retention of the conductor wires in the proper concentric fabricated orientation for reduced wire fatigue at the point adjacent the connector. To terminate an end of the cable with a connector, a segment of the outer layer of the cable is stripped off to expose the conductive polymer coating. The connector is then crimped over the conductive polymer coating.

### BRIEF DESCRIPTION OF THE DRAWINGS

FIG. 1 is a perspective view of an embodiment of a signal cable having a construction in accordance with the invention; and

FIG. 2 is a side view of an end of the signal cable with an end segment of its outer layer stripped to expose a conductive polymer coating onto which a connector is to be installed by crimping.

### DETAILED DESCRIPTION OF THE INVENTION

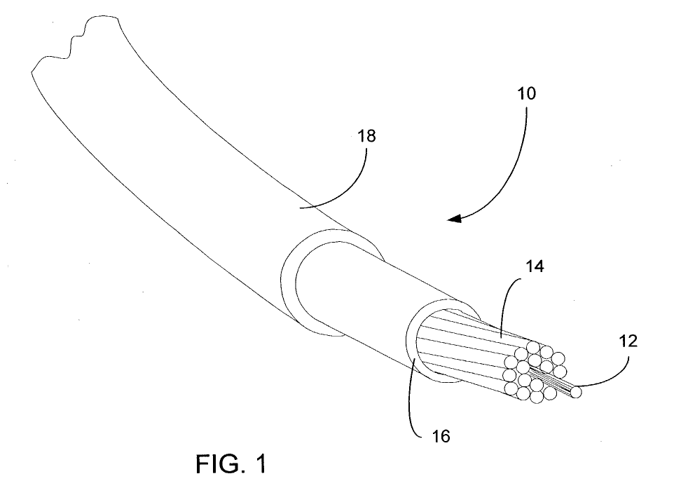

Now referring to the drawings, wherein like reference numerals refer to like elements, FIG. 1 shows an embodiment of a small-gauge signal cable 10 constructed in accordance with the invention. As shown in FIG. 1, the signal cable 10 has a fiber core 12 and a plurality of conductor wires 14 surrounding the fiber core in a generally concentric fashion. The conductor wires 14 in turn are surrounded by a layer of conductive polymer coating 16. Outside the conductive polymer coating is an outer protective insulation layer or jacket 18.

In accordance with a feature of the invention, the fiber core 12 at the center of the signal cable 10 provides improved flexibility to the cable. Moreover, it also imparts significantly improved break strength to the relatively thin cable. To that end, the fiber core 12 is formed of a fiber of high tensile strength, such as aramid.

To make the cable 10 thin and flexible, stranded thin conductor wires 14 are used to carry the electric signals. The conductor wires 14 are preferably formed of copper, but other types of metal, such as silver, aluminum, or steel, may be used depending on the applications. Each conductor wire 14 is preferably of #30 gauge or smaller. In a preferred embodiment, the cable has a overall #20 gauge construction that has eighteen (18) soft #34 gauge copper wires selected for long flex life of the cable.

In accordance with another feature of the invention, the conductor wires 14 are inside a layer of conductive polymer coating 16. The coating 16 may be formed by extruding the conductive polymer over the conductor wires 12. The conductive polymer used in the coating 16 may be, for instance, polyolefin doped with 50% or more carbon black to provide electrical conductivity, and preferably has a thickness of 8-15 mil (where one mil is 1/1000th of an inch).

The conductive polymer coating 16 serves multiple purposes. First, it protects the conductor wires 12 from being damaged when the outer jacket 20 is stripped off for installing a connector on the cable 10. During the stripping operation, even though the cutting edge of the stripping tool may cut slightly into the conductive polymer coating 16, the thickness of the coating reduces the likelihood of the tool reaching the conductor wires. As a result, it is much easier to strip the outer jacket 18 cleanly without damaging the conductor wires.

In accordance with an aspect of the feature of the invention, the conductive polymer coating 16 also makes the termination of the cable significantly easier because a connector can be crimped directly onto the conductive polymer coating. This way of attaching the connector to the cable has several significant advantages. First, it eliminates the need to carefully strip the cable to expose the fragile conductor wires 14. Second, because the outer diameter of the coating layer 16 is greater than that of the conductive wires 14 alone, and the conductive polymer is more compliant than the metal of the conductive wires, it is easier to ensure that a good physical contact is formed at the crimp point. Moreover, the coating 16 provides retention of the conductor wires in the concentric fabricated orientation to reduce wire fatigue behind the connector.

Over the conductive polymer coating 16 is an outer jacket 18, which is formed of an insulator polymer, such as PE, PVC, rubber, neoprene, etc. The jacket 18 insulates the cable 10 from the surrounding environment and also provides abrasion protection. The jacket 18 may be formed by extruding the polymer material over the conductive polymer coating 16. To enhance the ease of stripping the outer jacket 18 for cable termination, preferably an anti-tacking agent is used between the conductive polymer coating 16 and the outer jacket 18 during the extrusion process to prevent adhesion of the jacket material to the conductive polymer coating.

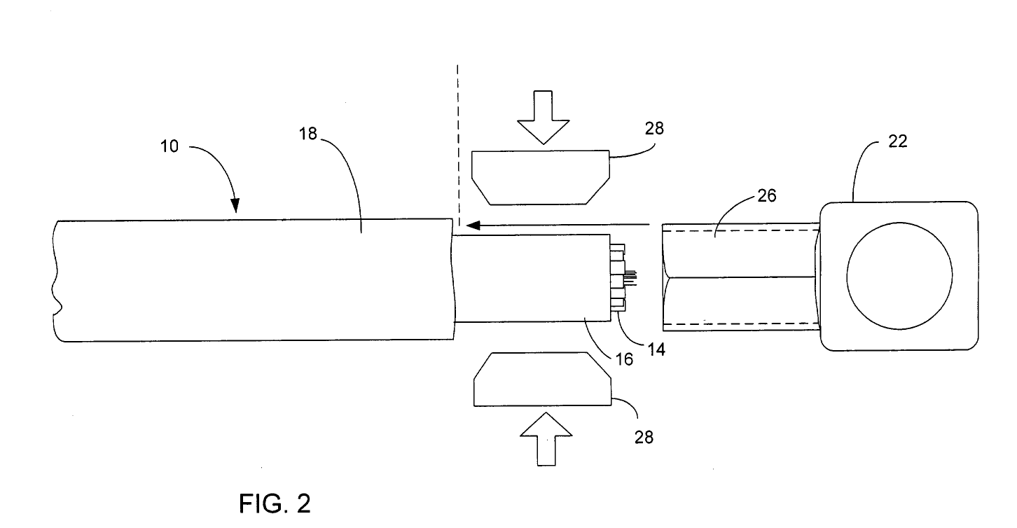

Referring now to FIG. 2, as mentioned above, a feature of the invention is that the cable 10 is designed to be terminated by crimping a connector 22 onto the conductive polymer coating 16, rather than the conductor wires. Such a termination is feasible, because the cable 10 is intended to carry small control signals, so the conductive polymer at the crimp point is not expected to carry a large amount of current. As illustrated in FIG. 2, to terminate an end of the cable 10, an end segment of the outer jacket 18 at that end is stripped off using a proper stripping tool to expose the conductive polymer coating 16. The ferrule 26 of the connector 22 is then slid over the conductive polymer coating 16 and crimped onto the conductive polymer coating 16 using a proper crimping tool 28.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A small-gauge signal cable comprising:
a central fiber core made of high-tensile strength fibers;
a plurality of conductor wires stranded around the fiber core;
a conductive polymer coating layer over the conductive wire; and
an insulating protective outer jacket over the conductor polymer coating, wherein the insulating protective outer jacket is extruded over the conductive polymer coating layer with an anti-tacking agent between the insulating protective outer jacket and the conductive polymer coating layer to prevent adhesion of the insulating protective outer jacket to the conductive polymer coating layer.

2. A small-gauge signal cable as in claim 1, wherein each of the conductor wires is of #30 gauge or smaller.

3. A small-gauge signal cable as in claim 2, wherein the conductor wires are made of copper.

4. A small-gauge signal cable as in claim 1, wherein the conducting polymer coating layer is extruded over the conductive wires.

5. A small-gauge signal cable as in claim 1, wherein the conducting polymer coating layer is formed of a polymeric material containing carbon black.

6. A small-gauge signal cable as in claim 1, wherein the insulating protective outer jacket is extruded over the conductive polymer coating layer.

7. A small-gauge signal cable as in claim 1, further including a connector attached to an end section of the small-gauge signal cable, wherein the end section has a segment of the outer jacket stripped therefrom to expose the conductive poly coating layer, and the connector is crimped onto the exposed conductive polymer coating layer at the end section.

8. A method of terminating a small-gauge signal cable with a connector, the small gauge signal cable having a central fiber core made of high-tensile strength fibers, a plurality of conductor wires stranded around the fiber core, a conductive polymer coating layer over the conductor wires, and an insulating protective outer jacket over the conductive polymer coating, the method comprising:
Stripping off a segment of the outer jacket at an end section of the small-gauge signal cable to expose the conductive polymer coating layer; and
crimping the connector onto the conductive polymer coating layer at the end section of the small-gauge signal cable.

9. A small-gauge signal cable comprising:
a central fiber core made of high-tensile strength fibers;
a plurality of conductor wires stranded around the fiber core;
a conductive polymer coating layer over the conductive wire;
an insulating protective outer jacket over the conductor polymer coating, and
a connector attached to an end section of the small-gauge signal cable, wherein the end section has a segment of the outer jacket stripped therefrom to expose the conductive poly coating layer, and the connector is crimped onto the exposed conductive polymer coating layer at the end section to form an electrical connection.

10. A small-gauge signal cable as in claim 1, wherein each of the conductor wires is of #30 gauge or smaller.

11. A small-gauge signal cable as in claim 10, wherein the conductor wires are made of copper.

12. A small-gauge signal cable as in claim 9, wherein the conducting polymer coating layer is extruded over the conductive wires.

13. A small-gauge signal cable as in claim 9, wherein the conducting polymer coating layer is formed of a polymeric material containing carbon black.

14. A small-gauge signal cable as in claim 9, wherein the insulating protective outer jacket is extruded over the conductive polymer coating layer with an anti-tacking agent between the insulating protective outer jacket and the conductive polymer coating layer to prevent adhesion of the insulating protective outer jacket to the conductive polymer coating layer.
